(19) United States
(12) Patent Application Publication
(10) Pub. No.: US 2025/0300385 A1
(43) Pub. Date: Sep. 25, 2025

(54) CONNECTOR

(71) Applicant: Yazaki Corporation, Tokyo (JP)

(72) Inventor: Kozo OISHI, Shizuoka (JP)

(73) Assignee: Yazaki Corporation, Tokyo (JP)

(21) Appl. No.: 19/084,856

(22) Filed: Mar. 20, 2025

(30) Foreign Application Priority Data
Mar. 25, 2024 (JP) 2024-047734

(51) Int. Cl. H01R 13/405; H01R 13/52; H01R 13/652; H01R 107/00

(52) U.S. Cl. CPC H01R 13/405; H01R 13/521; H01R 13/652; H01R 2107/00; H01R 2201/26

(57) ABSTRACT

A connector includes a connection member, and a housing in which a part of the connection member is insert molded. The connection member has a fixing plate portion, a support plate portion raised from the fixing plate portion, and a base portion connected continuously to the support plate portion and in which a plurality of tab portions are formed. The base portion has a first base portion connected continuously to the end portion of the support plate portion, and a second base portion formed on the side portion of the first base portion and folded back. The tab portion is connected continuously to the end portion of the second base portion and formed to be bent with respect to the second base portion, a bent portion is formed at the root portion of the tab portion, and a water stop material application portion is formed in the support plate portion.

### CROSS-REFERENCE TO RELATED APPLICATIONS

The present application is based on, and claims priority from the Japanese Patent Application No. 2024-047734, filed on Mar. 25, 2024, the entire contents of which are incorporated herein by reference.

### TECHNICAL FIELD

The present disclosure relates to a connector.

### BACKGROUND

As a ground joint connector for collectively connecting a plurality of electric wires to a ground portion of a vehicle, there is the ground joint connector in which the connection member, which is made of a conductive metal material and has a plurality of tab portions, is integrally provided in the resin housing (see JP 2016-110713 A). The connection member includes a fixing plate portion fixed to the vehicle, a support plate portion raised from the fixing plate portion, and a base portion which is connected continuously to the support plate portion and in which a plurality of tab are protrusively formed.

### SUMMARY OF THE INVENTION

In a ground joint connector, after insert molding, there may be a small gap between the connection member and the housing due to a difference between a volume reduction rate of the connection member (metal) and a volume reduction rate of the housing (resin). For this reason, insert molding is generally performed on the connection member in a state where a water stop material is applied to the entire circumference of the support plate portion of the connection member to solidify the water stop material. However, in a case where the water stop material is applied to the support plate portion of the connection member, if the water stop material flows into and adheres to the tab portion due to dripping of the water stop material, a resistance value of the tab portion increases.

An object of the present disclosure is to provide a connector capable of preventing a water stop material from flowing into and adhering to a tab portion when the water stop material is applied to a support plate portion of a connection member.

A connector according to an embodiment includes: a connection member which is made of a conductive metal material and has a plurality of tab portions; and a resin housing in which a part of the connection member is insert molded, in which the connection member has: a fixing plate portion which is fixed to a vehicle; a support plate portion which is raised from the fixing plate portion; and a base portion which is connected continuously to the support plate portion and in which the plurality of tab portions are protrusively formed, the base portion has: a first base portion which is connected continuously to an end portion of the support plate portion in a first direction; and a second base portion which is formed on a side portion of the first base portion in a second direction intersecting with the first direction and is folded back to overlap with the first base portion, the tab portion is connected continuously to an end portion of the second base portion in a first direction and formed to be bent with respect to the second base portion, a bent portion is formed at a root portion of the tab portion, and a water stop material application portion is formed in the support plate portion.

The configuration described above makes it possible to provide a connector capable of preventing a water stop material from flowing into and adhering to a tab portion when the water stop material is applied to a support plate portion of a connection member.

### BRIEF DESCRIPTION OF DRAWINGS

FIG. 1 is an exploded perspective view illustrating an example of a ground joint connector according to a present embodiment.

FIG. 2 is a perspective view illustrating an example of a male connector according to the present embodiment.

FIG. 3 is a front view illustrating an example of the male connector according to the present embodiment.

FIG. 4 is a cross-sectional view taken along the line A-A of FIG. 3.

FIG. 5 is a cross-sectional view taken along the line B-B of FIG. 3.

FIG. 6 is a perspective view of a ground terminal member.

FIG. 7 is a side view of the ground terminal member.

FIG. 8 is a schematic perspective view of a blank material before forming the ground terminal member.

FIG. 9 is a schematic plan view of the blank material before forming the ground terminal member.

FIG. 10 is an explanatory diagram of the process of applying a water stop material to the ground terminal member.

FIG. 11 is an explanatory diagram of the process of applying a water stop material to the ground terminal member.

### DETAILED DESCRIPTION OF THE INVENTION

Hereinafter, a connector according to a present embodiment will be described in detail with reference to the drawings. The dimensional ratios in the drawings are exaggerated for the sake of explanation and may differ from the actual ratios.

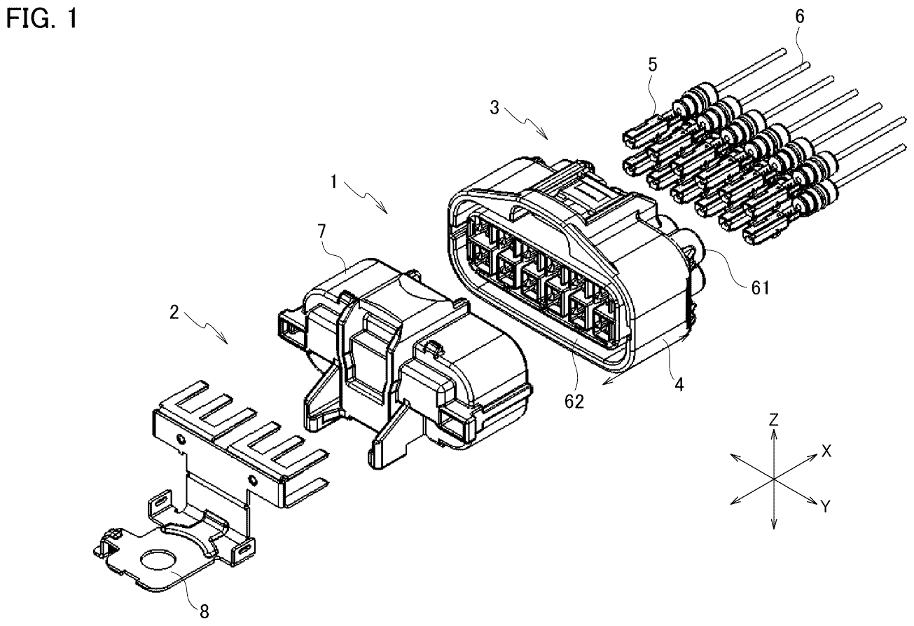

As illustrated in FIG. 1, the ground joint connector 1 is constituted by combining a connector (male connector 2) and a mating connector (female connector 3). The mating connector (female connector 3) is fitted to the connector (male connector 2) according to the present embodiment.

The X direction illustrated in FIG. 1 is a direction along the length direction of an electric wire 6 connected to the ground joint connector 1, and corresponds to the joint direction (front-rear direction) with the male connector 2 and the female connector 3 in the ground joint connector 1. Further, the Y direction illustrated in FIG. 1 corresponds to the left-right direction (width direction) of the ground joint connector 1, and is orthogonal to the X direction. Furthermore, the Z direction illustrated in FIG. 1 corresponds to the height direction (up-down direction) of the ground joint connector 1, and is orthogonal to the X direction and the Y direction.

First, the mating connector (female connector 3) will be described.

The female connector 3 includes a resin mating housing (female housing 4). The female housing 4 has a plurality of terminal accommodating chambers 61, and the tip end side of the female housing 4 is a fitting portion 62. The plurality of terminal accommodating chambers 61 are formed along the joint direction (X direction) with the male connector 2. In addition, the plurality of terminal accommodating chambers 61 are arranged in the female housing 4 in the Y direction, and are arranged in two upper and lower stages.

A female terminal 5 is accommodated (inserted) in the terminal accommodating chamber 61 from the rear end side which is the rear side in the joint direction with the male connector 2. The female terminal 5 is made of a conductive metal material such as copper or copper alloy. An electric wire 6 covering the circumference of the conductor with an outer covering is crimped and electrically connected to the female terminal 5. The female terminal 5 is inserted into the terminal accommodating chamber 61 from the rear end side of the female housing 4, and thus the electric connection portion of the female terminal 5 is engaged with a lance part (not illustrated) in the terminal accommodating chamber 61. This makes it possible to maintain a state in which the female terminal 5 is held in the terminal accommodating chamber 61.

Next, the connector (male connector 2) will be described.

The male connector 2 includes a resin housing (male housing 7). A fitting recess 11 is formed in the male housing 7, and the fitting recess 11 has an open tip end side which is the front side in the joint direction with the female connector 3. The mating connector (female connector 3) is joined to the connector (male connector 2) by fitting the fitting portion 62 of the female housing 4 into the fitting recess 11 of the male housing 7.

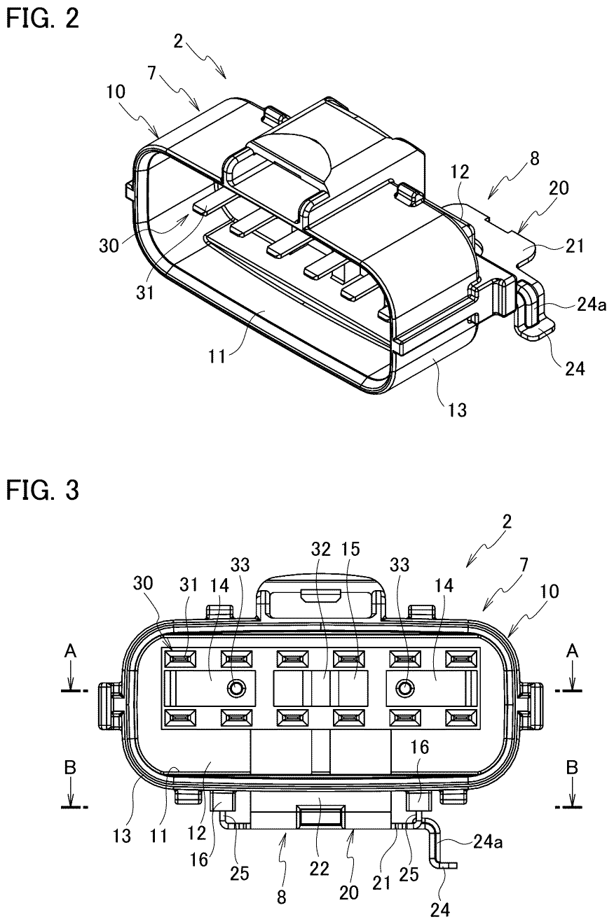

As illustrated in FIGS. 2 to 5, the male connector 2 has the housing (male housing 7) and a connection member (ground terminal member 8).

The male housing 7 has a hood portion 10, and the inside of the hood portion 10 is the fitting recess 11. The hood portion 10 has a rear wall portion (bottom wall portion 12), and a peripheral wall portion 13 extending from the periphery of the bottom wall portion 12 to the tip end side. An annular packing (not illustrated) is fitted into the hood portion 10 of the male housing 7. The packing stops water between the fitting recess 11 and the fitting portion 62 when the fitting portion 62 of the female housing 4 is fitted into the fitting recess 11 of the male housing 7.

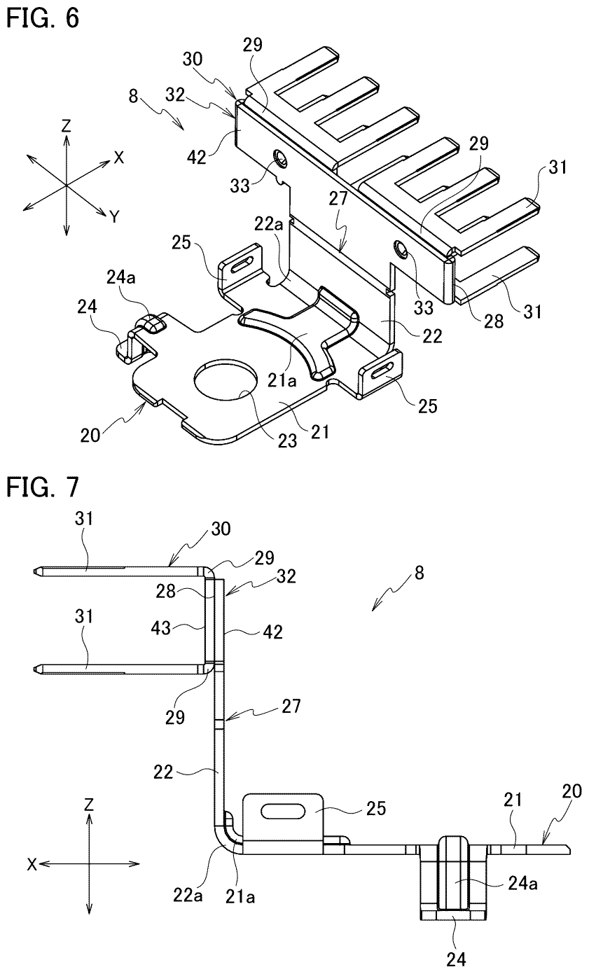

As illustrated in FIGS. 6 and 7, the ground terminal member 8 has a bus bar 20 and a terminal fitting 30. The bus bar 20 and the terminal fitting 30 are made of a conductive metal material such as copper or copper alloy, and are integrally formed by press working.

The bus bar 20 has a flat fixing plate portion (body fixing portion 21) and a support plate portion (neck portion 22) raised from the body fixing portion 21. A bolt insertion hole 23 is formed in the body fixing portion 21. By fastening a bolt (not illustrated) inserted into the bolt insertion hole 23 to the body of a vehicle (vehicle body), the body fixing portion 21 is fastened and fixed to the vehicle body, thereby grounding the bus bar 20. A ground terminal (not illustrated) of a ground wire is fastened to the body fixing portion 21 with the bolt. An rotation stopper piece 24 is formed in a part of the body fixing portion 21. The rotation stopper piece 24 is a bent portion engaged with a step portion or a hole portion around the ground plane where the body fixing portion 21 is bolted, and the rotation stopper piece 24 is engaged with a step portion or a hole portion around the ground plane, thereby inhibiting the body fixing portion 21 to rotate with respect to the ground plane.

A convex portion 21a for increasing the rigidity of the bus bar 20 is formed from the body fixing portion 21 to the neck portion 22. In addition, a convex portion 24a for increasing the rigidity of the rotation stopper piece 24 is formed in the rotation stopper piece 24.

At the end portion of the body fixing portion 21 on the neck portion 22 side (a portion near the neck portion 22), a rib portion (reinforcing rib 25) which is vertically raised from the body fixing portion 21 is formed on both sides in the Y direction. The upper portions of a pair of reinforcing ribs 25 and 25 are at least covered with the resin portions (covering portions 16) protruding from the male housing 7 (see FIGS. 3 to 5). When vibration is applied in a state where the ground joint connector 1 is fixed to the vehicle body, due to vibration transmitted through the female connector 3, a large load may be repeatedly applied to the root portion 22a of the neck portion 22 positioned between the neck portion 22 and the body fixing portion 21 of the ground terminal member 8. By employing the structure of the ground terminal member 8 as described above, the load applied to the ground terminal member 8 through the female connector 3 can be dispersed, thereby avoiding the load from being concentrated and applied to the root portion 22a of the neck portion 22 of the ground terminal member 8.

Further, in the ground joint connector 1, the current flowing from the female connector 3 passes through the plurality of tab portions 31 of the ground terminal member 8 and merges at the neck portion 22, and flows from the body fixing portion 21 to the vehicle body. At this time, the current is concentrated in the neck portion 22, which may increase the amount of heat generated in the neck portion 22. By employing the ground terminal member 8 having the rib portions (reinforcing ribs 25) as described above, the effect of heat dissipation caused by the rib portions (reinforcing ribs 25) can be obtained, thereby reducing the amount of heat generated in the neck portion 22 and suppressing an increase in temperature.

Here, if the reinforcing ribs 25 are arranged on both sides of the neck portion 22 in the Y direction (the portions indicated by reference numerals 41 in FIG. 9), the height of the reinforcing ribs 25 cannot be secured because the tab portions 31 are provided outside in the Y direction in a blank material 40 (a plate material before being bent to form the ground terminal member 8). In contrast, in the present embodiment, since the reinforcing ribs 25 are arranged on both sides of the body fixing portion 21 in the Y direction, the tab portions 31 are not positioned outside in the Y direction in the blank material 40, thereby securing the height of the reinforcing ribs 25 (see FIG. 9). In addition, since the reinforcing ribs 25 are positioned in the region that is discarded without being used, the yield of the material can be improved.

The terminal fitting 30 has a base portion 32 and a plurality of tab portions 31. The base portion 32 is formed into a flat plate shape, and the tab portions 31 protrude from the edge portion of the base portion 32 in the same direction. In the ground terminal member 8, a plurality of tab portions 31 protruding in the direction orthogonal to the surface of the base portion 32 are arranged in two upper and lower stages.

As illustrated in FIGS. 2 to 5, the ground terminal member 8 is insert molded into the male housing 7. Thus, the ground terminal member 8 is integrally formed in a state where the neck portion 22 of the bus bar 20 and the base portion 32 of the terminal fitting 30 are buried in the bottom wall portion 12 forming the fitting recess 11 of the male housing 7. The plurality of tab portions 31 of the ground terminal member 8 protrudes from the bottom wall portion 12 into the fitting recess 11.

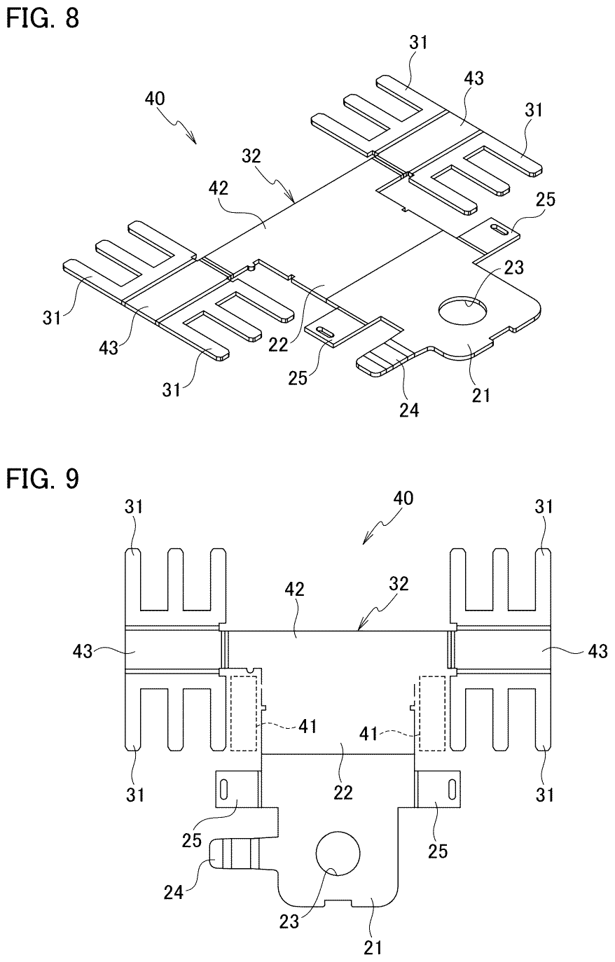

The ground terminal member 8 is formed by punching out a metal plate to prepare the blank member 40 (see FIGS. 8 and 9), and bending the blank member 40. As illustrated in FIGS. 8 and 9, the blank member 40 has a portion, which constitutes the bus bar 20, formed on one end side of the blank member 40, and a portion, which constitutes the terminal fitting 30, formed on the other end side of the blank member 40. In addition, the blank member 40 has a portion, which constitutes the neck portion 22, formed between the bus bar 20 and the terminal fitting 30.

Further, the base portion 32 of the terminal fitting 30 has a first base portion 42, and a pair of second base portions 43 and 43 which are connected continuously to both sides of the first base portion 42 in the Y direction, respectively. The tab portion 31 is formed in each of the second base portions 43, and the root portions of the second base portions 43 are folded back 180 degrees and overlapped with the first base portion 42, and the root portions of the plurality of tab portions 31 are folded about 90 degrees. For this reason, a folded portion 28 which is folded back 180 degrees is formed between the first base portion 42 and the second base portion 43, and the bent portions 29 which are bent about 90 degrees are formed at the root portions of the plurality of tab portions 31 (see FIGS. 6 and 7). Further, a rivet-retaining portion 33 making the second base portion 43 fixed to the first base portion 42 is formed by riveting a part of the overlapped portion of the first base portion 42 and the second base portion 43 (see FIG. 6).

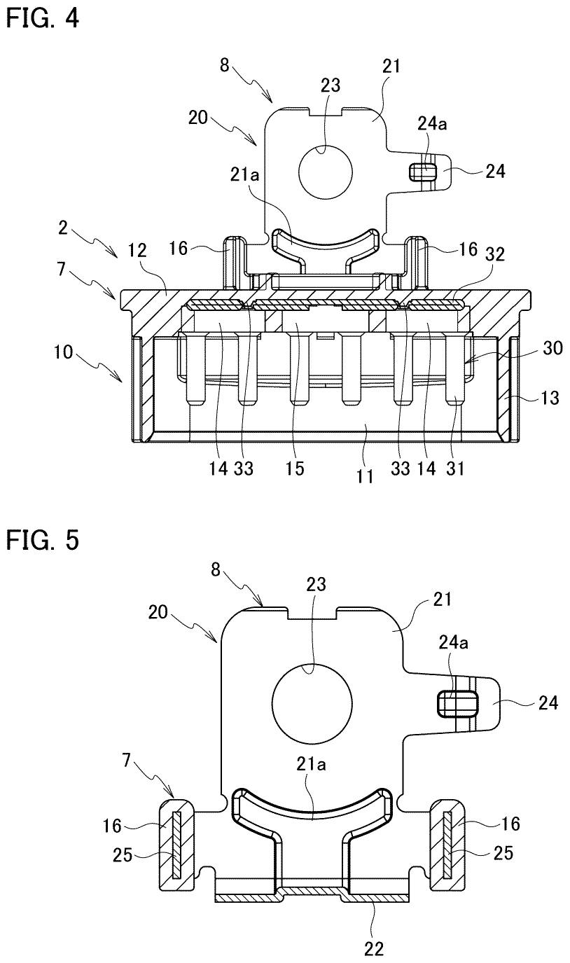

In the present embodiment, the center portions of the rivet-retaining portion 33 and the base portion 32 in the Y direction are not covered with resin (a part of the male housing 7), but exposed from the exposed portions (hollowed portions 14 and 15) (see FIGS. 3 and 4). Since the rivet-retaining portion 33 is exposed from the hollowed portion 14 after insert molding, it is possible to detect a failure of riveting by visual inspection after insert molding. In addition, the amount of resin used is reduced compared to the case in which the rivet-retaining portion 33 is also covered with resin, thereby reducing the weight of the male connector 2.

Meanwhile, the overall volume of the male housing 7 decreases because the resin shrinks after insert molding. In addition, the volume of the ground terminal member 8, which is heated and thermally expanded during insert molding, also decreases after insert molding. However, since the volume reduction rate of the male housing 7 is larger than that of the ground terminal member 8, there may be a small gap between the ground terminal member 8 and the male housing 7 in the male connector 2 due to a difference in the volume reduction rates. Therefore, insert molding is performed on the ground terminal member 8 in a state where a water stop material application portion 27 (see FIGS. 6 and 7) is formed on the entire circumference of the neck portion 22 of the ground terminal member 8.

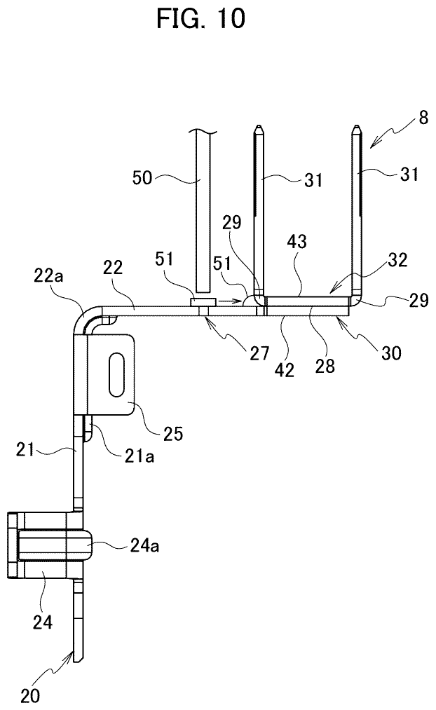

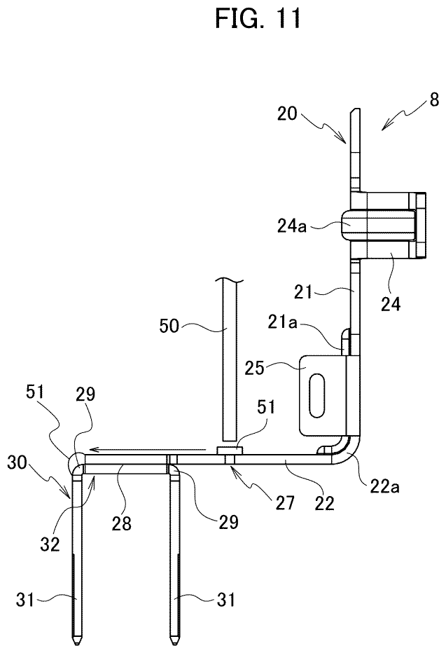

A water stop material 51 (see FIGS. 10 and 11) is applied to the ground terminal member 8 before the stage of insert molding. For example, the water stop material 51 is used to have the property of being liquid when applied to the ground terminal member 8 and solidifying when dried.

First, as illustrated in FIG. 10, the ground terminal member 8 is disposed with the tab portion 31 facing upward, and the water stop material 51 is applied to the neck portion 22 of the bus bar 20 using a nozzle 50 such as a dispenser. At this time, since the bent portion 29 is formed at the root portion of the tab portion 31 as a liquid dripping prevention portion at the front side, thereby preventing the water stop material 51 from flowing into the tab portion 31 by means of the bent portion 29 at the front side. That is, even if the water stop material 51 drips when the water stop material 51 is applied to the neck portion 22 of the ground terminal member 8, the water stop material 51 stops at a portion between the bent portion 29 at the front side and the outer surface of the neck portion 22, thereby preventing the water stop material 51 from flowing into the tab portion 31.

Next, as illustrated in FIG. 11, the ground terminal member 8 is disposed with the tab portion 31 facing downward, and the water stop material 51 is also applied to the opposite surface of the neck portion 22 of the bus bar 20 using the nozzle 50. At this time, since the bent portion 29 is formed at the root portion of the tab portion 31 as a liquid dripping prevention portion at the rear side, thereby preventing the water stop material 51 from flowing into the tab portion 31 by means of the bent portion 29 at the rear side. That is, even if the water stop material 51 drips when the water stop material 51 is applied to the neck portion 22 of the ground terminal member 8, the water stop material 51 stops at a portion between the bent portion 29 at the rear side and the end surface of the neck portion 22, thereby preventing the water stop material 51 from flowing into the tab portion 31.

Thus, the connector (male connector 2) according to an aspect of the present embodiment includes the connection member (ground terminal member 8) which is made of a conductive metal material and has a plurality of tab portions 31. The connector (male connector 2) includes the resin housing (male housing 7) in which a part of the connection member (ground terminal member 8) is insert molded. The connection member (ground terminal member 8) has the fixing plate portion (body fixing portion 21) which is fixed to a vehicle, and the support plate portion (neck portion 22) which is raised from the fixing plate portion (body fixing portion 21). The connection member (ground terminal member 8) has the base portion 32 which is connected continuously to the support plate portion (neck portion 22) and in which the plurality of tab portions 31 are protrusively formed. The base portion 32 has the first base portion 42 which is connected continuously to the end portion of the support plate portion (neck portion 22) in the first direction (Z direction). The base portion 32 has the second base portion 43 which is formed on the side portion of the first base portion 42 in the second direction (Y direction) intersecting with the first direction (Z direction) and is folded back to overlap with the first base portion 42. The tab portion 31 is connected continuously to the end portion of the second base portion 43 in the first direction (Z direction) and formed to be bent with respect to the second base portion 43, the bent portion 29 is formed at the root portion of the tab portion 31, and the water stop material application portion 27 is formed in the support plate portion (neck portion 22).

When the water stop material 51 is applied to the neck portion 22, the bent portion 29 prevents the water stop material 51 from flowing into the tab portion 31, thereby preventing the water stop material 51 from adhering to the tab portion 31.

As described above, the present embodiment makes it is possible to provide the connector (male connector 2) capable of preventing the water stop material 51 from flowing into and adhering to the tab portion 31 when the water stop material 51 is applied to the support plate portion (neck portion 22) of the connection member (ground terminal member 8).

In the connector (male connector 2), the water stop material application portion 27 may apply the water stop material to the entire circumference of the support plate portion (neck portion 22) to solidify the water stop material.

When the water stop material 51 is applied to the neck portion 22, the bent portion 29 prevents the water stop material 51 from flowing into the tab portion 31, thereby preventing the water stop material 51 from adhering to the tab portion 31.

In the connector (male connector 2), the tab portion 31 may be connected continuously to both end portions of the second base portion 43 in the first direction (Z direction), and the bent portion 29 may be formed at each root portion of the tab portion 31 connected continuously to both end portions of the second base portion 43 in the first direction (Z direction).

By employing a bent structure in which the tab portion 31 is connected continuously to both end portions of the second base portion 43 in the Z direction and the tab portion 31 is bent at the root portion, it is possible to improve the yield of material (see FIG. 9).

In the connector (male connector 2), the second base portion 43 may be connected continuously to both side portions of the first base portion 42 in the second direction (Y direction). The folded portion 28 may be formed between the first base portion 42, and the second base portion 43 which is connected continuously to both side portions of the first base portion 42 in the second direction (Y direction).

By employing a folding back structure in which the second base portion 43 is connected continuously to both end portions of the first base portion 42 in the Y direction and the second base portion 43 is folded back at the root portion, it is possible to improve the yield of material (see FIG. 9).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector, comprising:
a connection member which is made of a conductive metal material and has a plurality of tab portions; and
a resin housing in which a part of the connection member is insert molded, wherein the connection member includes:
a fixing plate portion which is fixed to a vehicle;
a support plate portion which is raised from the fixing plate portion; and
a base portion which is connected continuously to the support plate portion and in which the plurality of tab portions are protrusively formed,
the base portion includes:
a first base portion which is connected continuously to an end portion of the support plate portion in a first direction; and
a second base portion which is formed on a side portion of the first base portion in a second direction intersecting with the first direction and is folded back to overlap with the first base portion,
the tab portion is connected continuously to an end portion of the second base portion in a first direction and formed to be bent with respect to the second base portion,
a bent portion is formed at a root portion of the tab portion, and
a water stop material application portion is formed in the support plate portion.

2. The connector according to claim 1, wherein
the water stop material application portion applies a water stop material to an entire circumference of the support plate portion to solidify the water stop material.

3. The connector according to claim 1, wherein
the tab portion is connected continuously to both end portions of the second base portion in the first direction, and
the bent portion is formed at each root portion of the tab portion connected continuously to both end portions of the second base portion in the first direction.

4. The connector according to claim 1, wherein
the second base portion is connected continuously to both side portions of the first base portion in the second direction, and
a folded portion is formed between the first base portion, and the second base portion which is connected continuously to both side portions of the first base portion in the second direction.
